(19) United States
(12) Patent Application Publication
(10) Pub. No.: US 2014/0055986 A1
(43) Pub. Date: Feb. 27, 2014

(54) Lighted Safety Garment

(71) Applicants: Eulalio Corpus, JR., San Antonio, TX (US); Jessie Davis, Floresville, TX (US)

(72) Inventors: Eulalio Corpus, JR., San Antonio, TX (US); Jessie Davis, Floresville, TX (US)

(21) Appl. No.: 13/972,243

(22) Filed: Aug. 21, 2013

Related U.S. Application Data
(60) Provisional application No. 61/692,140, filed on Aug. 22, 2012.

(51) Int. Cl. F21V 33/00

(52) U.S. Cl. CPC F21V 33/0008
USPC 362/108

(57) ABSTRACT

A lighted safety garment having a safety vest with a front surface, a back surface and a shoulder area; a first flexible LED strip and a second flexible LED strip attached to said front surface; at least one first strobe light attached to said vest at said shoulder area; at least one second strobe light attached to said vest at said back surface; a power source electrically coupled to said first flexible LED strip, said second flexible LED strip, said at least one first strobe light, and said at least one second strobe light.

### CROSS REFERENCE TO RELATED APPLICATIONS

This original non-provisional application claims the benefit of U.S. Provisional Application Ser. No. 61/692,140, filed Aug. 22, 2012, which is incorporated by reference herein.

### STATEMENT REGARDING FEDERALLY SPONSORED RESEARCH OR DEVELOPMENT

Not applicable.

### BACKGROUND OF THE INVENTION

The present invention relates to safety apparel. More specifically, the present invention is an improved safety garment.

### BRIEF SUMMARY OF THE INVENTION

The present invention provides an improved safety garment that can be used by persons in a variety of occupations, such as construction workers, paramedics, and police, and allows for use of both hands for a given task. The invention comprises a multi-use lighted vest that emits a sufficient amount of light in front of the wearer to allow the wearer to see in front of them for an extended distance. This allows the wearer to walk in dark, enclosed or open spaces while keeping both hands free. The wearer will have both hands free to perform a variety of tasks that would otherwise require the use of a flashlight. The wearer is also benefitted from the increased visibility to others that a lighted safety garment provides. Being more visible to others in hazardous environments and work zones increases safety.

The present invention comprises a safety vest having a front surface, a back surface and a shoulder area; a first flexible LED strip and a second flexible LED strip attached to said front surface; at least one first strobe light attached to said vest at said shoulder area; at least one second strobe light attached to said vest at said back surface; a power source electrically coupled to said first flexible LED strip, said second flexible LED strip, said at least one first strobe light, and said at least one second strobe light.

### BRIEF DESCRIPTION OF THE SEVERAL VIEWS OF THE DRAWINGS

FIG. 1 shows a front view of an embodiment of the invention.

FIG. 2 shows a back view of the embodiment shown in FIG. 1.

### DETAILED DESCRIPTION OF THE VARIOUS EMBODIMENTS

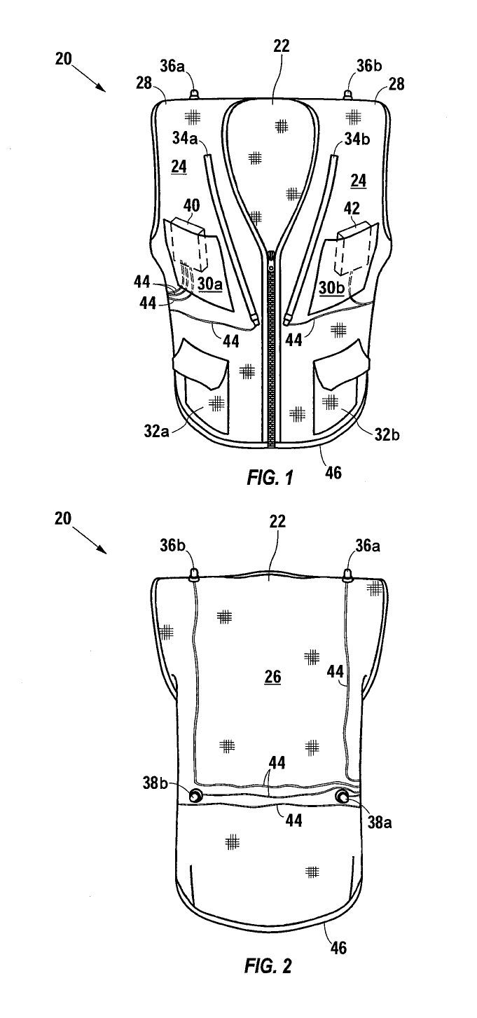

Referring to FIGS. 1-2, the embodiment 20 comprises a Type 2 ANS/ISEA 107-2010 safety vest 22 having a front surface 24, a back surface 26, a shoulder area 28 that intersects a portion of the front surface 24 and the back surface 26, and a bottom edge 46. Patch-type pockets 30a-b are formed at the front surface 24 of the vest 22. Flap-type pockets 32a-b are formed at the front surface 24 of the vest 22 below the patch pockets 30a-b.

Two flexible LED lighting strips 34a-b are attached (e.g., adhered) to the front surface 24 in a “V” configuration. In this embodiment, the flexible LED lighting strips 34a-b are each an ALPENA brand of flexible LED strips available from Marklyn Group Inc., Ontario, Canada.

A first pair of LED strobe lights 36ab is attached (e.g., adhered) to the vest 22 at the shoulder area 28. A second pair of LED strobe lights 38a-b is attached (e.g., adhered) to the vest 22 on the back surface 26 between the shoulder area 28 and the bottom edge 28. In this embodiment, each strobe light is an ALPENA STROBELITZ.

Each LED strip 34a-b and each strobe 36a-b, 38a-b utilize 5053 0.5 W LEDs having a brightness of forty-five to fifty-five lumens. The first and second pairs of strobe lights 36a-b, 38a-b and lighting strips 34a-b are electrically coupled to a power supply control 40, such as an ALPENA strobe control module available from StreetGlow, Inc. of Lodi, N.J., located in one patch pocket 30a. The power supply control 40 is electrically coupled to a power source, such as a rechargeable lithium-ion battery 42 located in the other patch pocket 30b, with insulated conductors 44. The power supply control 40 provides the circuitry necessary to change the operating mode of the garment as well as flash timing of the strobe lights 36a-b, 38a-b.

The electrical coupling of the various components is as follows. The battery 42 is electrically coupled to each flexible LED strip 34a-b and the power supply control 40. The first pair of strobes 36a-b and the second pair of strobes 38a-b are also electrically coupled to the power supply control 40, with the internal circuitry of the power supply control 40 electrically interposed between the battery 42 and the first and second pairs of strobe lights 36a-b, 38a-b. Flash speed of the strobe lights 36a-b, 38a-b may be altered using the power supply control 40. In addition, the mode of flashing may be altered by the power supply control 40. Electrical coupling is accomplished with insulated conductors 44. Although exposed on the front and back surfaces 24, 26 of the vest 22, in an alternative embodiment, the conductors may be attached to the inside surfaces of the vest 22. In still other embodiments, the conductors 44 may be covered with fabric or reflective tape.

In use, the present invention provides additional light when compared with a flashlight or a helmet headlight, which are directional. The embodiment 20 can illuminate a 180-degree arc in front, left to right and above front of the wearer. In this way, the present invention enables people to see at night in a hands-free manner without needing to hold a flashlight or another light source. The rear facing second pair of LED strobe lights 38a-b provide illumination behind the wearer for increased safety and visibility to others.

The method of attachment of the lights to the garment, while not discussed in the previous embodiment, can be achieved by many different methods well known to those skilled in the art. One particularly advantageous method of attachment is by fabric hook-and-loop strips which is one possible type of detachable attachment. The advantage of this method is that the lighting components may be optionally removed for cleaning and replacement. This embodiment also allows some flexibility in the placement of the lights upon the garment to achieve the wearer's optimally desired performance.

The present invention is described above in terms of a preferred illustrative embodiment of a specifically-described lighted safety garment. Those skilled in the art will recognize that alternative constructions of such an apparatus can be used in carrying out the present invention. Other aspects, features, and advantages of the present invention may be obtained from a study of this disclosure and the drawings, along with the appended claims.

I claim:

1. A lighted safety garment comprising:
a safety vest having a front surface, a back surface and a shoulder area;
a first flexible LED strip and a second flexible LED strip attached to said front surface;
at least one first strobe light attached to said vest at said shoulder area;
at least one second strobe light attached to said vest at said back surface;
a power source electrically coupled to said first flexible LED strip, said second flexible LED strip, said at least one first strobe light, and said at least one second strobe light.

2. The lighted safety garment of claim 1 further comprising a power supply controller electrically interposed between said power source and said at least one first strobe light.

3. The lighted safety garment of claim 2 wherein said power supply controller is electrically interposed between said power source and said at least one second strobe light.

4. The lighted safety garment of claim 1 wherein said first flexible LED strip and said second flexible LED strip are attached to said front surface in a “V” configuration.

5. The lighted safety garment of claim 1 wherein said first flexible LED strip, said second flexible LED strip, said at least one first strobe light, and said power source, are removably attached to said safety vest.

6. The lighted safety garment of claim 1 wherein the insulated conductors that electrically couple the said a power source to the said first flexible LED strip, said second flexible LED strip, and said at least one first strobe light are at least partially covered and adjacent to the surface of said safety vest.

7. The lighted safety garment of claim 6 wherein the at least partially covered insulated conductors are covered by reflective tape.

8. The lighted safety garment of claim 1 wherein the insulated conductors that electrically couple the said a power source to the said first flexible LED strip, said second flexible LED strip, said at least one first strobe light, are at least partially located adjacent to the interior surface of said a safety vest and within the volume partially defined by the inner surface of said safety vest.
